(19) United States
(12) Patent Application Publication
(10) Pub. No.: US 2024/0154332 A1
(43) Pub. Date: May 9, 2024

(54) CABLE CONNECTOR

(71) Applicant: Hirose Electric Co., Ltd., Yokohama (JP)

(72) Inventors: Chunkai YANG, Yokohama (JP); Kento UENO, Yokohama (JP)

(21) Appl. No.: 18/387,418

(22) Filed: Nov. 6, 2023

(30) Foreign Application Priority Data
Nov. 8, 2022 (JP) 2022-178843

(51) Int. Cl. H01R 12/72; H01R 12/73; H01R 13/66

(52) U.S. Cl. CPC H01R 12/722; H01R 12/73; H01R 13/6625

(57) ABSTRACT

It is an object to provide a cable connector capable of performing reliable communication of digital signals between devices with respect to AC-coupled signals using DC blocking. The inventive cable connector 1 comprises a first connector section 4 having a first connector 10 comprising multiple terminals 12, and a first connector substrate 30 having multiple wires 32 placed thereon; a second connector section 6 having a second connector 16 comprising multiple terminals 18, and a second connector substrate 34 having multiple wires 36 placed thereon; a cable section 2, 2a for electrically connecting the multiple wires 32, 36 to one another; and multiple capacitors 40 for DC blocking provided in the first connector section.

### BACKGROUND

### Cross-Reference to Related Applications

This application claims priority to Japanese Patent Application No. 2022-0178843, filed Nov. 8, 2022, the contents of which are incorporated herein by reference in its entirety for all purposes.

### TECHNICAL FIELD

The present invention is concerned with cable connectors and, in particular, relates to a cable connector for interconnecting predetermined devices.

### RELATED ART

Heretofore, there have been known cable connectors for connecting, for example, a motherboard (a device) and a device such as a hard disk, and communicating high-speed signals/high-frequency signals therebetween. For example, Patent Document 1 discloses a cable connector construction having a first printed wiring board with a first connector connected thereto enclosed in a top housing and a bottom housing; a second printed wiring board with a second connector connected thereto enclosed in a top housing and a bottom housing; and a cable connecting multiple wires placed on these printed wiring boards to one another.

### PATENT DOCUMENTS

### Patent Document 1

U.S. Patent Publication No. 2005/0130490.

### SUMMARY

### Problems to be Solved

Incidentally, in recent years, as devices, etc., become faster, increased speeds have also come to be required of signal transmission technologies. In addition to conventional signal processing devices such as servers, cloud computing, data centers, and notebook PCs, faster transmission standards for devices have come to be required in recent years across a wide range of fields, such as in devices used in the automotive field, including in in-vehicle devices.

Here, depending on the specifications of the devices to be connected, there may be cases in which, for example, one device (including its circuits and substrate) has circuits driven by 2.5V-referenced alternating voltage signals, and another device has circuits driven by 0V-referenced alternating voltage signals, and there is a difference in ground potentials between these devices. A problem that arises in case of such a difference in ground potentials between the devices is that the level of signal voltage ends up shifting by an “offset voltage” between the transmission-side device and the reception-side device, thereby making the threshold values of the “0s” and “1s” of the data different, as a result of which the “1s” and “0s” of digital signals cannot be discriminated and the data can no longer be correctly transmitted.

By contrast, a technique called alternating current coupling/AC coupling is known to be used for handling high-speed signals. In the case of such AC coupling circuits, communication of digital signals between devices is made possible by disposing “capacitors” on wires and using a technique called DC blocking, which makes use of such capacitors, to remove the offset DC component in order to provide a 0V reference and equalize the ground levels of alternating voltage.

However, in the past, such DC blocking capacitors disposed on AC coupling circuits were surface mounted on device substrates (typically, on motherboards) and correspondingly occupied mounting space on the substrates, which created another problem in terms of being a hindrance to designing/implementing high-density wire packing on the substrates.

The present invention, which was devised to eliminate the above-described issues, has the object of providing a cable connector allowing for reliable communication of digital signals between devices to be accomplished without requiring capacitors on the devices that are mated.

### Technical Solution

In order to achieve the above-mentioned object, the present invention, which is a cable connector for interconnecting predetermined devices, is characterized by comprising: a first connector section, which has a first connector comprising multiple terminals and a first connector substrate having said first connector attached thereto, and in which multiple wires electrically connected to the multiple terminals of the first connector are placed on the first connector substrate; a second connector section, which has a second connector comprising multiple terminals and a second connector substrate having said second connector attached thereto, and in which multiple wires electrically connected to the multiple terminals of the second connector are placed on the second connector substrate; a cable section for respectively electrically connecting the multiple wires placed on the first connector substrate and the multiple wires placed on the second connector substrate; and multiple capacitors for DC blocking provided at least in one of the first connector section or second connector section.

### Technical Effect

If the inventive cable connector is used, reliable communication of digital signals between devices can be accomplished without requiring capacitors on the devices that are mated.

### BRIEF DESCRIPTION OF THE DRAWINGS

FIG. 1 is a perspective view of the cable connector according to an embodiment of the present invention.

FIG. 2 is a perspective view illustrating the cable connector according to the present embodiment, and device substrates being connected to the connector portions thereof.

FIG. 3 is a perspective view illustrating a state in which each connector proximal to a device substrate has been mated with a connector portion of the cable connector according to the present embodiment.

FIG. 4 is a plan view illustrating a state in which each connector proximal to a device substrate has been mated with a connector portion of the cable connector according to the present embodiment.

FIG. 5 is a cross-sectional view seen along line V-V line in FIG. 4.

FIG. 6 is a perspective view of the second connector section of the cable connector according to the present embodiment as seen obliquely from below.

FIG. 7 is a perspective view illustrating the cable connector according to the present embodiment in an exploded condition.

FIG. 8 is a perspective view illustrating the two connector sections of the cable connector of the present embodiment and the cable portion that connects them.

FIG. 9 is a partially enlarged perspective view illustrating, in enlarged detail, an encircled region IX in the first connector section of the cable connector illustrated in FIG. 8.

FIG. 10 is a plan view of the cable connector illustrated in FIG. 8.

FIG. 11 is a partially enlarged plan view illustrating, in enlarged detail, an encircled region XI in the first connector section illustrated in FIG. 10.

### DETAILED DESCRIPTION

Below, embodiments of the invention will be described with reference to drawings.

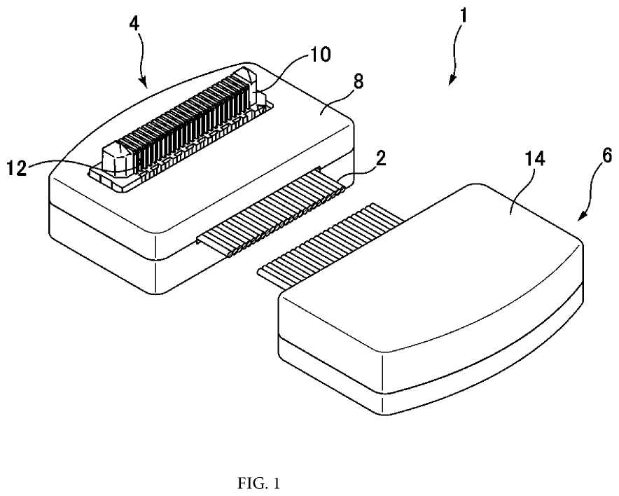

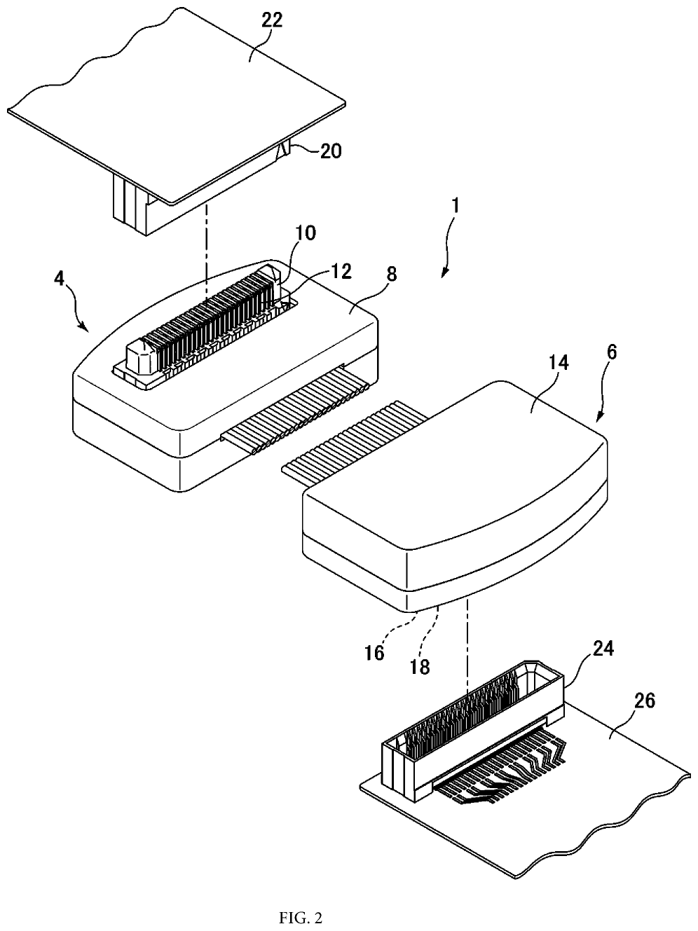

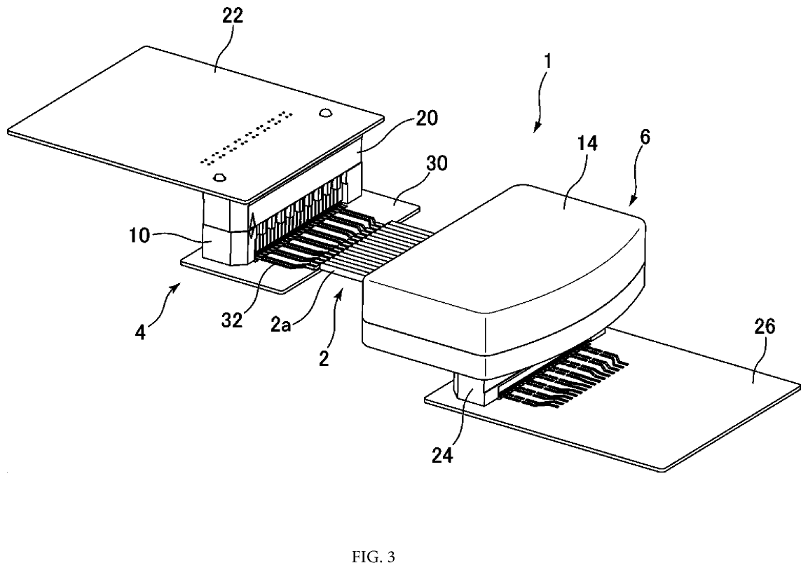

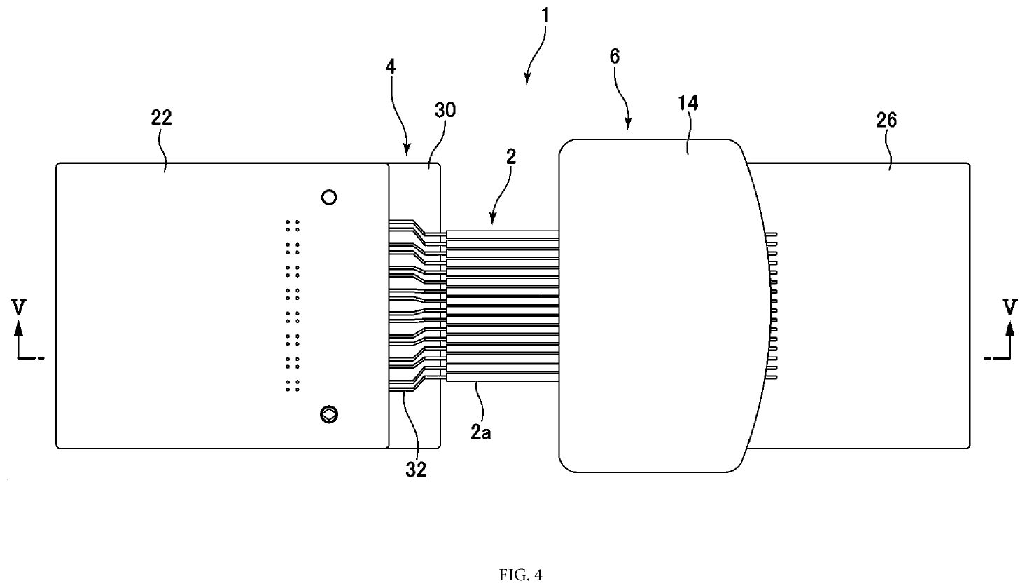

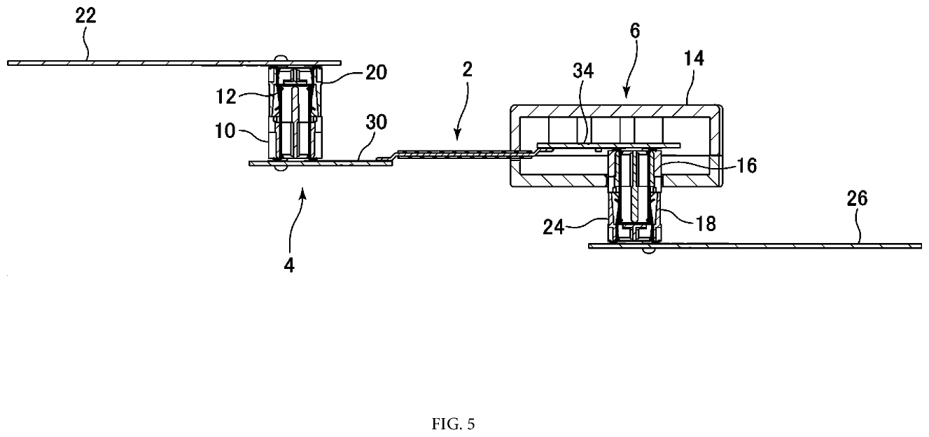

First, the overall configuration of the cable connector according to an embodiment of the present invention as well as the manner in which it is mated with the devices will be described with reference to FIGS. 1 to 5. FIG. 1 is a perspective view of the cable connector according to an embodiment of the present invention, FIG. 2 is a perspective view illustrating the cable connector according to the present embodiment, and device substrates being connected to the connector portions thereof, FIG. 3 is a perspective view illustrating a state in which each connector proximal to a device substrate has been mated with a connector portion of the cable connector according to the present embodiment, FIG. 4 is a plan view illustrating a state in which each connector proximal to a device substrate has been mated with a connector portion of the cable connector according to the present embodiment, and FIG. 5 is a cross-sectional view seen along line V-V line in FIG. 4.

First, as shown in FIGS. 1 and 2, the cable connector 1 according to an embodiment of the present invention has a first connector section 4 and a second connector section 6 electrically connected to each other by a cable body (cable section) 2.

First, the first connector section 4 comprises a connector (first connector) 10 accommodated in a housing 8 and attached to the housing 8, with the connector 10 protruding and extending upward from the housing 8 in the assembled condition illustrated in FIGS. 1 and 2. In the connector 10, there are provided multiple conductor terminals 12 exposed in the portion protruding from the housing 8.

It should be noted that illustration of the housing 8 in the hereinafter-described FIGS. 3 to 5 is omitted for ease of discussion.

Further, the second connector section 6 comprises a connector (second connector) 16 accommodated in a housing 14 and attached to the housing 14, with the connector 16 protruding and extending downward from the housing 14 in the assembled condition illustrated in FIGS. 1 and 2. In the connector 16, there are provided multiple conductor terminals 18 exposed in the portion protruding from the housing 14.

Further, in this example, as shown in FIGS. 2 to 5, the first connector 10 is adapted to be mated with a motherboard 22 comprising a counterpart connector 20, as a counterpart device for mating. More particularly, the counterpart connector 20 comprises multiple terminals, and the connector 10, by mating with this counterpart connector 20, is electrically connected thereto. The motherboard 22 comprises electrical circuits driven by a predetermined alternating voltage, and these electrical circuits include an AC coupling circuit.

Similarly, in this example, as shown in FIGS. 2 to 5, a second connector 16 is adapted to be mated with a motherboard 26 comprising a counterpart connector 24, as a counterpart device for mating. More particularly, the counterpart connector 24 comprises multiple terminals, and the connector 16, by mating with this counterpart connector 24, is electrically connected thereto. The motherboard 26 comprises electrical circuits driven by a predetermined alternating voltage, and these electrical circuits include an AC coupling circuit.

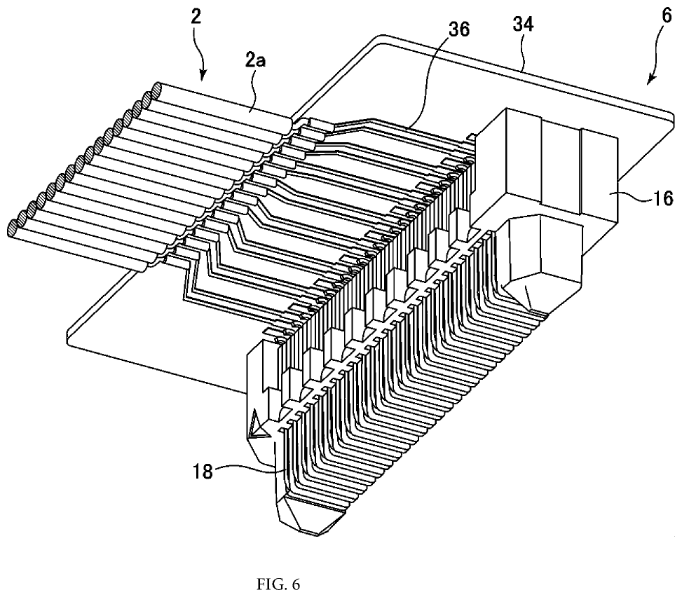

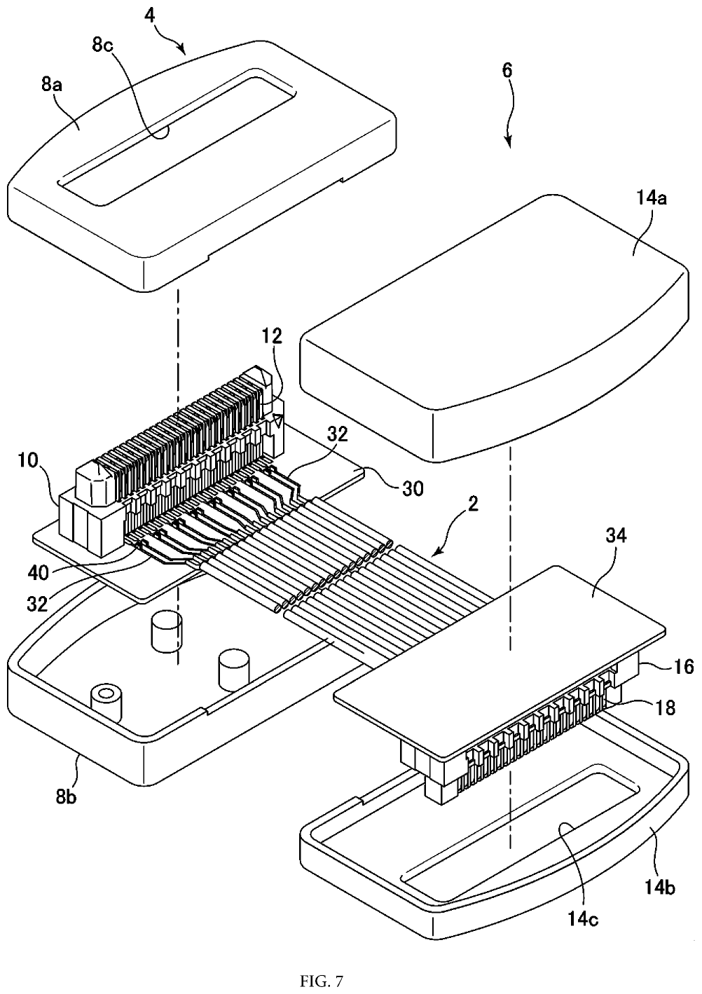

Now, the construction of the cable connector according to the present embodiment will be described in greater detail with reference to FIGS. 3 to 7. FIG. 6 is a perspective view of the second connector section of the cable connector according to the present embodiment as seen obliquely from below, and FIG. 7 is a perspective view illustrating the cable connector according to the present embodiment in an exploded condition.

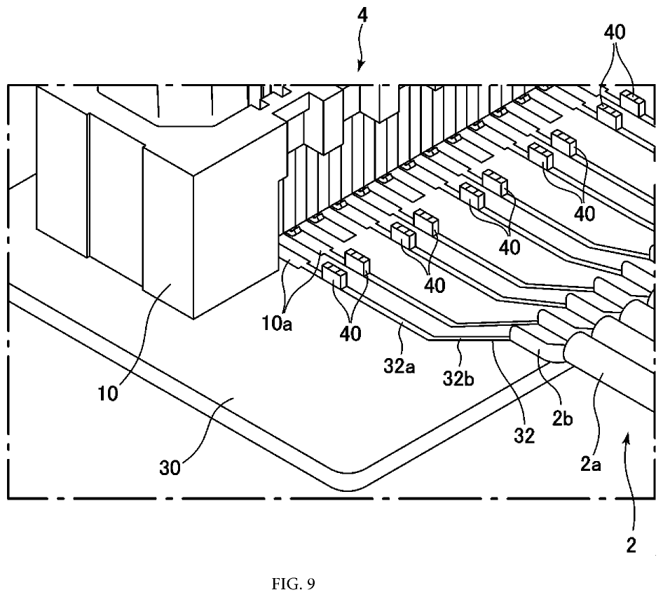

First, as shown in FIGS. 3 to 5, the first connector section 4 has a connector substrate (first connector substrate) 30, to which the first connector 10 is attached. The multiple terminals 12 of the first connector 10 extend downwardly within the first connector 10, and extend to mounting portions (proximal end portions 10a, see FIG. 9) used to attach to the substrate 30 of the first connector 10.

Further, as shown in FIGS. 3 and 4, multiple conductor wires 32 are disposed on the surface of the connector substrate 30 in a manner such as to extend from the proximal end portions 10a of the connector 10 to the connection portions 2b of the cable body 2 (see FIG. 9). The multiple wires 32 have their ends on one side respectively connected to the multiple terminals 12 of the connector 10, and their ends on the other side respectively connected to multiple conductor cables 2a comprised in the cable body 2.

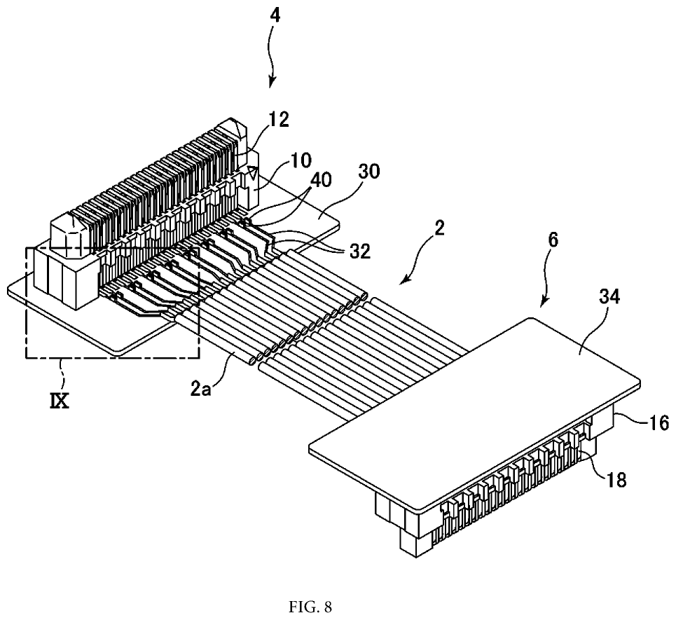

Here, capacitors 40 used for the hereinafter-described DC blocking are respectively provided on the multiple wires 32 (see FIGS. 7, 8, etc.).

Further, as shown in FIG. 6, the second connector section 6 has a connector substrate (second connector substrate) 34, to which the second connector 16 is attached. The multiple terminals 18 of the second connector 16 extend downwardly within the second connector 16, and extend to mounting portions (proximal end portions) used to attach to the substrate 34 of the second connector 16.

Further, multiple conductor wires 36 are disposed on the surface of the connector substrate 34 in a manner such as to extend from the proximal end portions of the connector 16 to the connection portions of the cable body 2. The multiple wires 36 have their ends on one side respectively connected to the multiple terminals 18 of the connector 16, and their ends on the other side respectively connected to the multiple conductor cables 2a comprised in the cable body 2.

Now, the construction of the housing of the connector assembly of the cable connector 1 will be described with reference to FIG. 7.

As shown in FIG. 7, the housing 8 of the first connector section 4 has a top housing 8a, which is formed with a downwardly cupped cavity, and a bottom housing 8b, which is formed with an upwardly cupped cavity, and the above-described connector 10 and connector substrate 30 are adapted to be accommodated within these cavities. An opening portion 8c, through which a section of the terminals 12 of the connector 10 protrudes upward, is formed in the top housing 8a.

On the other hand, the housing 14 of the second connector section 6 has a top housing 14a, which is formed with a downwardly cupped cavity, and a bottom housing 14b, which is formed with an upwardly cupped cavity, and the above-described connector 16 and connector substrate 34 are adapted to be accommodated within these cavities. An opening portion 14c, through which a section of the terminals 18 of the connector 16 protrudes downward, is formed in the bottom housing 14b.

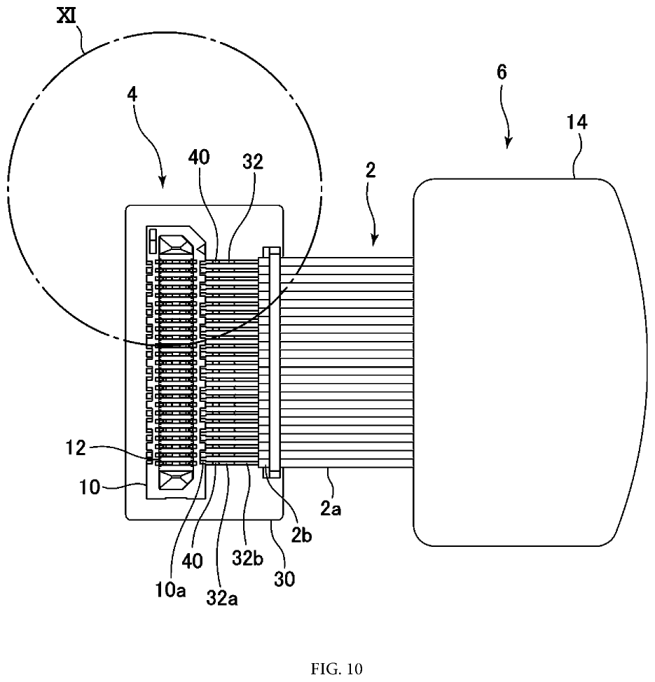

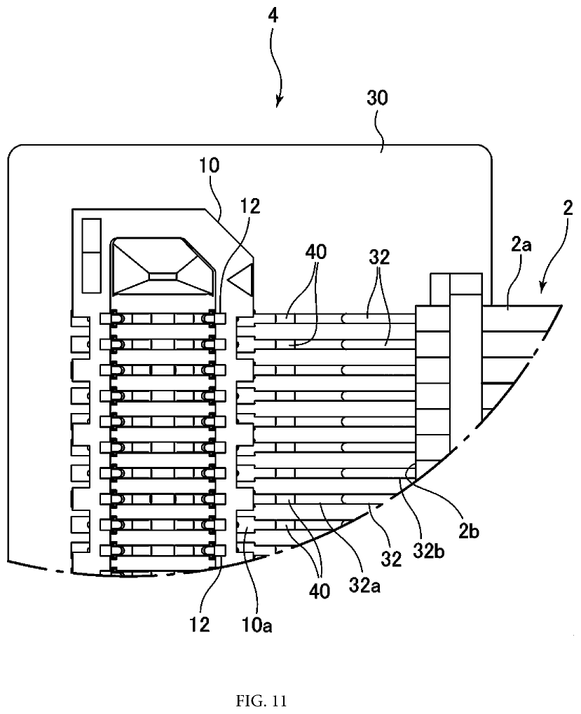

Now, the arrangement of the capacitors 40 used for DC blocking in the present embodiment will be described with reference to FIGS. 8 to 11. FIG. 8 is a perspective view illustrating the two connector sections of the cable connector of the present embodiment and the cable portion that connects them, FIG. 9 is a partially enlarged perspective view illustrating, in enlarged detail, an encircled region IX in the first connector section of the cable connector illustrated in FIG. 8, FIG. 10 is a plan view of the cable connector illustrated in FIG. 8, and FIG. 11 is a partially enlarged plan view illustrating, in enlarged detail, an encircled region XI in the first connector section illustrated in FIG. 10. It should be noted that in FIG. 10 the housing of the second connector section is shown in addition to the cable connector of FIG. 8.

First, as shown in FIGS. 8 and 9, multiple capacitors 40 are provided on the connector substrate 30 of the first connector section 4. More particularly, the capacitors 40 are provided respectively on the multiple conductor wires 32 placed on the connector substrate 30 so as to pass the electric current of alternating voltage that flows through these wires 32.

These capacitors 40 are capacitors (AC coupling capacitors, DC blocking capacitors) provided for so-called AC-coupled signals and their role, in this example, is to make communication of digital signals between the devices 22, 26 (only their motherboards are illustrated in FIG. 8, etc.) possible by removing the offset DC component between the devices 22, 26 using a technique called DC blocking to thereby provide a 0V reference and equalize the ground levels of alternating voltage of the devices 22, 26. That is to say, when the capacitors 40 of the present embodiment are electrically connected to the AC coupling circuit (devices 22, 26) via the connector terminals 12, 18 and the cables 2a, the function performed thereby is not the ordinary power storage function of capacitors, but a DC blocking function. As described above, the devices 22, 26 comprise electrical circuits driven by predetermined alternating voltages and these electric circuits include AC coupling circuits, and the capacitors 40 provided in the cable connector 1 according to the present embodiment perform DC blocking for these devices 22, 26.

Here, in the present embodiment, as described above, the multiple capacitors 40 are provided only on the multiple wires 32 of the first connector section 4.

However, as a variation, DC blocking may be adapted to operate using both the first connector section 4 and the second connector section 6 by providing, for example, a capacitor 40 on just one wire 32 in a set of two adjacent wires 32 among the multiple wires 32 of the first connector section 4 while providing a capacitor 40 on a wire 36 of the second connector section 6, to which the other wire 32, not provided with a capacitor 40, is electrically connected. Providing the capacitors 40 alternatingly on adjacent wires among the wires 32, 36 in this manner may serve, for example, to achieve denser packing of the wires 32, 36 on the connector substrates 30, 34.

Further, as shown in FIGS. 8 and 9, the multiple wires 32 on the connector substrate 30 extend from the proximal end portions 10a of the connector 10 (which are also the starting end portions of the wires 32) to the connection portions 2b of the cable body 2 (which are also the terminal end portions of the wires 32). The multiple wires 32 have surface placement sections 32a, which are placed in a manner such as to be formed directly on the surface of the connector substrate 30 throughout their entire length, and spaced placement sections 32b, which are placed in a manner such as to extend from the terminal ends of the surface placement sections 32a to the connection portions 2b used to connect to the cable body 2 while being spaced upwardly from the connector substrate 30.

The capacitors 40 are provided on the surface placement sections 32a of the wires 32. Specifically, as shown in FIG. 9, within these surface placement sections 32a, the capacitors 40 are provided at locations adjacent the proximal end portions 10a of the connector 10, thereby minimizing alternating voltage noise between the devices 22, 26.

The effects of the cable connector 1 according to an embodiment of the present invention will be described below.

First, the cable connector 1 according to the present embodiment and variations comprises (A) a first connector section 4, which has a first connector 10 comprising multiple terminals 12 and a first connector substrate 30 having said first connector attached thereto, and in which multiple wires 32 electrically connected to the multiple terminals of the first connector are placed on the first connector substrate; (B) a second connector section 6, which has a second connector 16 comprising multiple terminals 18 and a second connector substrate 34 having said second connector attached thereto, and in which multiple wires 36 electrically connected to the multiple terminals of the second connector are placed on the second connector substrate; (C) a cable section 2, 2a for respectively electrically connecting the multiple wires placed on the first connector substrate and the multiple wires placed on the second connector substrate, and (D) multiple capacitors 40 for DC blocking provided in at least one of the first connector section or second connector section.

If the thus-configured cable connector 1 according to the present embodiment and variations is used, reliable communication of digital signals between the devices 22, 26 can be accomplished using DC blocking without requiring capacitors on the devices 22, 26 that are mated.

It should be noted that the individual embodiments of the present invention are not independent and can be appropriately implemented in combinations with one another. In addition, the embodiments described above are illustrations used to explain the present invention, and the present invention is not limited to these embodiments. The present invention can be implemented in various forms without deviating from the essence thereof.

### INDUSTRIAL APPLICABILITY

The inventive cable connector can be employed for applications such as communication of high-speed signals/high-frequency signals between devices comprising AC coupling circuits.

### DESCRIPTION OF THE REFERENCE NUMERALS

1 Cable connector
2 Cable body (cable section)
2a Conductor cables
2b Connection portions (terminal end portions of the wires 32)
4 First connector section
6 Second connector section
8 Housing
10 Connector (first connector)
10a Connector-proximal end portions (proximal end portions of the wires 32)
12 Terminals
14 Housing
16 Connector (second connector)
18 Terminals
20, 24 Counterpart connectors
22, 26 Motherboards (devices)
30 Connector substrate (first connector substrate)
32 Wires on the substrate
32a Surface placement sections
32b Spaced placement sections
34 Connector substrate (second connector substrate)
36 Wires on the substrate
40 Capacitors

1. A cable connector for interconnecting predetermined devices, comprising:
a first connector section, which has a first connector comprising multiple terminals and a first connector substrate having said first connector attached thereto, and in which multiple wires electrically connected to the multiple terminals of the aforementioned first connector are placed on the aforementioned first connector substrate;
a second connector section, which has a second connector comprising multiple terminals and a second connector substrate having said second connector attached thereto, and in which multiple wires electrically connected to the multiple terminals of the aforementioned second connector are placed on the aforementioned second connector substrate;
a cable section for respectively electrically connecting the multiple wires placed on the aforementioned first connector substrate and the multiple wires placed on the aforementioned second connector substrate; and
multiple capacitors for DC blocking provided in at least one of the aforementioned first connector section or the aforementioned second connector section.

2. The cable connector according to claim 1 wherein the aforementioned multiple capacitors are provided only in the aforementioned first connector section, and
the aforementioned multiple capacitors are respectively provided on the multiple wires on the aforementioned first connector substrate.

3. The cable connector according to claim 2 wherein the aforementioned multiple capacitors are provided respectively adjacent to the aforementioned first connector on the multiple wires on the aforementioned first connector substrate.

4. The cable connector according to claim 1 wherein the aforementioned cable connector is a cable connector in which a counterpart connector of a predetermined first device comprising an AC coupling circuit is mated with the first connector of the aforementioned first connector section, and a counterpart connector of a predetermined second device comprising an AC coupling circuit is mated with the second connector of the aforementioned second connector section.

5. The cable connector according to claim 2 wherein the aforementioned cable connector is a cable connector in which a counterpart connector of a predetermined first device comprising an AC coupling circuit is mated with the first connector of the aforementioned first connector section, and a counterpart connector of a predetermined second device comprising an AC coupling circuit is mated with the second connector of the aforementioned second connector section.
